(19) United States
(12) Patent Application Publication
(10) Pub. No.: US 2014/0124080 A1
(43) Pub. Date: May 8, 2014

(54) EXTRUDED MOLDED ARTICLE, PARTICULARLY A MOLDED TUBE, WITH AN EMBEDDED REINFORCEMENT MADE OF A FINE KNIT AND METHOD FOR PRODUCTION THEREOF

(71) Applicant: ContiTech MGW GmbH, Hannoversch-Muenden (DE)

(72) Inventors: Joerg Hellfeier, Hannoversch-Muenden (DE); Antje Meister, Northeim (DE); Michael Ahrens, Einbeck (DE)

(73) Assignee: ContiTech MGW GmbH, Hannoversch-Muenden (DE)

(21) Appl. No.: 14/153,705

(22) Filed: Jan. 13, 2014

Related U.S. Application Data
(63) Continuation of application No. PCT/EP2012/064073, filed on Jul. 18, 2012.

(30) Foreign Application Priority Data
Aug. 16, 2011 (DE) 10 2011 052 723.0

(51) Int. Cl. F16L 11/08; B29C 65/70

(52) U.S. Cl. CPC F16L 11/08; B29C 65/70
USPC 138/137; 156/148

(57) ABSTRACT

A molded article, particularly a molded tube, having at least the following layer structure: an inner layer and an outer layer each made from a polymeric material, particularly in the form of a vulcanized material; and, a reinforcement layer, particularly consisting of a textile material, embedded between the inner layer and the outer layer. The inner layer and the outer layer are extruded, and the reinforcement layer is a knit with a high mesh count and a low mesh height. In addition, a method for producing such a molded article is described, particularly with regard to the vulcanization in a mold.

### CROSS REFERENCE TO RELATED APPLICATIONS

This application is a continuation application of international patent application PCT/EP2012/064073, filed Jul. 18, 2012, designating the United States and claiming priority from German application 10 2011 052 723.0, filed Aug. 16, 2011, and the entire content of both applications is incorporated herein by reference.

### FIELD OF THE INVENTION

A molded item is disclosed which has at least the following layer structure:
an internal layer and external layer made in each case of a polymeric material, and also
embedded between the internal layer and external layer, a reinforcement layer.

### BACKGROUND OF THE INVENTION

The molded item is in particular a molded hose, and a hose here with the abovementioned fundamental structure can also have, in addition to the internal layer, external layer, and reinforcement layer, other layers, for example an intermediate layer superposed on the internal layer. The hose technology relevant here is in particular described in more detail in the following patent literature:

| | |
|---|---|
| DE 41 18 023 A1 | U.S. Pat. No. 6,626,211 |
| DE 10 2008 037 417 A1 | U.S. Pat. No. 7,044,168 |
| DE 10 2008 055 552 A1 | WO 2004/029493 A1 |
| US 2012/0145275 | WO 2007/045322 A1 |
| DE 10 2010 000 180 A1 | U.S. Pat. No. 4,273,160 |
| U.S. Pat. No. 5,660,210 | US 2009/0211660 A1 |

Further details are given below concerning the prior art for molded hoses, these being described in the form of vulcanizates with a three- and four-layer hose structure in particular in US 2012/0145275 and WO 2007/045322 A1.

In-mold-vulcanized hoses with a reinforcement layer have hitherto been designed as wound structures. Textiles or layers of material are wound on a build mandrel in succession here with appropriate overlap forming thick areas, and the design mostly has additional rubber material at the two ends. In order to achieve better adhesion and to avoid possible air inclusions, the structure is bandaged with a textile strip. Said bandage is in turn removed, and the preforms of the hoses are chopped to the required length. The preforms of the hoses are then drawn onto bellows rods and positioned. In the middle of the bellows rods there are rubber bellows, and these use a gas to press the preform of the hose against the two closed halves of a mold. After vulcanization, the preform of the hose has assumed the external shape that is associated with the mold and that mostly comprises folds which permit movement.

### SUMMARY OF THE INVENTION

The object of the invention is a further development consisting in provision of a molded item, in particular molded hose, which features a simple structure, where the function of any individual layer is not impaired in the event of any possible adhesion problems that arise within the assembly of layers. Another intention is, during the production of the molded item, to avoid the use of transverse seams and overlap seams, and also, in the context of prevention of handling errors, to avoid errors due to overfolding of reinforcement material, in particular in the form of a textile, during the drawing process. A final intention is that there be no further need for calendering and bandaging during the production of the molded item.

The object is achieved in that, in the novel molded item, in particular a molded hose,
the internal layer and external layer have been extruded, and that
the reinforcement layer is a knit with a high mesh count and with a small mesh height.

The following three material variants can be used for the extruded internal layer and external layer, and also for any appropriate other layers made of a polymeric material:

Elastomers

The elastomeric material based on a crosslinked rubber mixture which comprises an unblended rubber component or a rubber component blend and conventional mixture ingredients. Particular rubber components that may be mentioned are:

ethylene-propylene-rubber (EPM)

ethylene-propylene-diene copolymer (EPDM)

nitrile rubber (NBR)

(partially) hydrogenated nitrile rubber (HNBR)

fluororubber (FKM)

chloroprene rubber (CR)

natural rubber (NR)

styrene-butadiene rubber (SBR)

isoprene rubber (IR)

butyl rubber (IIR)

bromobutyl rubber (BIIR)

chlorobutyl rubber (CIIR)

brominated copolymer made of isobutylene and paramethylstyrene (BIMS)

butadiene rubber (BR)

chlorinated polyethylene (CM)

chlorosulfonated polyethylene (CSM)

polyepichlorohydrin (ECO)

terpolymer of ECO with ethylene oxide and with unsaturated monomers (ETER)

ethylene-vinyl acetate rubber (EVA)

acrylate rubber (ACM)

ethylene-acrylate rubber (AEM)

silicone rubber (MQ, VMQ, PVMQ, FVMQ; DE 10 2006 058 470 A1)

fluorinated methylsilicone rubber (MFQ)

perfluorinated propylene rubber (FFPM)

perfluorocarbon rubber (FFKM)

polyurethane (PU)

It is also possible to use a blend, in particular with one of the abovementioned types of rubber, for example an ACM/EPDM or ACM/AEM blend.

For the internal layer of a molded hose with resistance to the fluid to be transported, the following rubber components are of particular importance: ACM, AEM, and FKM.

For the external layer of a molded hose, in turn, the following rubber components are preferred: ACM, AEM, EPM, EPDM, FKM or VMQ.

Rubber mixtures usually also comprise other mixture ingredients, in particular a filler, such as carbon black, in addition to the crosslinking system, comprising a crosslinking agent and an accelerator. As required by the nature of the rubber mixture, which can be of various types in particular in the case of a multilayer hose, the mixture ingredients also comprise a processing aid and/or a plasticizer, and/or an antioxidant, and also optionally other additional substances, for example fibers and color pigments, and color pigments can in particular be important for the external layer here.

Rubber mixtures based on ACM or AEM are in particular crosslinked by a diamine system.

Rubber mixtures based on EPM, EPDM, or VMQ are in particular in turn subjected to peroxidic crosslinking.

Rubber mixtures based on FKM are in particular crosslinked by a bisphenol/peroxide system.

In relation to the materials ACM, AEM, EPM, and EPDM, reference is in particular made to US 2012/0145275.

In respect of the material VMQ, reference is in particular made to the two laid-open specifications DE 44 22 048 A1 and DE 10 2006 058 470 A1.

In relation to the material FKM, reference is in particular made to the German patent application DE 10 2011 050 882.1 published after the priority date of this application.

Thermoplastic Elastomers

A thermoplastic elastomer mixture comprises at least one thermoplastic component, at least one rubber component which has been at least partially crosslinked, and also conventional mixture ingredients.

The preferred thermoplastic components are:

polyolefin, in particular polyethylene (PE) or polypropylene (PP) polystyrene

polyamide (PA), for example PA6 or PA6.6

polyester, for example PET, PEN or PET

Particular rubber components that may be mentioned are ACM, AEM, EPM, EPDM and FKM.

In respect of the conventional mixture ingredients, reference is made to the mixing technology for the elastomers, in particular to the teaching of U.S. Pat. No. 6,774,162.

Thermoplastics

Other than the types of material already mentioned in the context of the thermoplastic components in the production of thermoplastic elastomers, mention may also be made here of the fluoroplastics, and in particular in turn of the following types:

polytetrafluoroethylene (PTFE)

modified polytetrafluoroethylene (TFM)

fluoroethylene polymer (FEP)

perfluoro(alkyl vinyl ether)-tetraethylene copolymer (PFA)

ethylene-tetrafluoroethylene copolymer (ETFE)

polyvinyl fluoride (PVF)

polyvinylidene fluoride (PVDF)

PTFE is of exceptional importance here.

When thermoplastics are used, the term “tube” is also used, as required by the nature of the thermoplastic, instead of the term “hose.” In respect of relevant developments here, reference is made by way of example to the laid-open specification DE 10 2008 037 490 A1, where a tube is presented, in particular a cooling-water tube, made of a thermoplastic.

The elastomers are of particular importance in the production of molded items, in particular molded hoses.

The reinforcement layer is composed of a knit, in particular based on a textile material, in particular in turn composed of yarns. The materials relevant here can be a polyamide (PA), a polyimide (PI), an aramid, in particular para-aramid or meta-aramid, a polyvinyl acetal (PVA), polyvinyl alcohol (PVAL), cotton (CO), modal (CMD), rayon (CV), a polyetheretherketone (PEEK), a polyester, in particular polyethylene therephthalate (PET) or polyethylene 2,6-naphthalate (PEN), a polysulfone (PSU), a polyoxadiazole (POD), polybenzoxazole (PBO), polyphenylene, or a polyphenylene derivative, in particular a polyphenylene sulfide. Hybrid designs, for example in the form of a mixed yarn can also be used. For the purposes of a relatively new hose development (DE 10 2008 037 417 A1) by way of example a hybrid design made of polyphenylene sulfide (PPS) and PA is used. The PPS is a high-performance material contributing to high strength, while the PA contributes not only to reinforcement but also, because it can be activated to provide adhesion, to improve adhesion with respect to the surrounding polymeric material.

The knit preferably has a mesh count of from 30 to 40 mesh, the size of the knitting head being from 2.5″ to 4″, a mesh count of in particular 36 mesh, the size of the knitting head being 3½″. The mesh height here is from 1.5 mm to 2.5 mm, in particular from 1.8 mm to 2.2 mm, in particular in turn 2 mm. The term fine knit is used when these mesh parameters apply.

Production of a molded hose here uses a circular knit with the abovementioned mesh parameters.

There are many possible uses of the molded hose, and by way of example here mention may be made of the cooling-water and charge-air sector.

Another molded item of the invention would be an item having the shape of a hose, for example an air-spring bellows.

In the simplest case, the molded item, in particular molded hose, can be a three-layer structure composed of an internal layer, reinforcement layer, and external layer. At least one other layer may also be present. Mention may be made here particularly of a four-layer structure composed of an internal layer, intermediate layer, reinforcement layer, and external layer. To the extent that the intermediate layer is composed of a polymeric material, this mostly being the case, said layer has also been extruded.

Another object of the invention consists in providing a process for the production of a molded item, in particular molded hose, which features a simple structure, where the function of any individual layer is not impaired in the event of any possible adhesion problems that arise within the assembly of layers. Another intention is, during the production of the molded item, to avoid the use of transverse seams and overlap seams, and also, in the context of prevention of handling errors, to avoid errors due to overfolding of reinforcement material, in particular in the form of a textile, during the drawing process. A final intention is that there be no further need for calendering and bandaging during the production of the molded item.

This object is achieved through at least the following steps:
the internal layer is formed through extrusion of a polymeric material (step I);
a knit with a high mesh count and with a small mesh height is applied to the internal layer, and specifically with formation of the reinforcement layer (step II);
the external layer is applied to the reinforcement layer through extrusion of a polymeric material (step III);
finally, the preform of the item, in particular the preform of the hose, is subjected to final operations in a mold (step IV).

In the formation of the internal layer and external layer in accordance with steps I and III, in each case an at least partially crosslinkable rubber mixture is in particular used, and for the purposes of the final operations here in accordance with step IV, the molded item, in particular molded hose, is vulcanized in a mold, and at least partial crosslinking takes place here. In respect of details of the rubber mixture, reference is made to the abovementioned materials section concerning the elastomers and thermoplastic elastomers.

For the purposes of the final operations in accordance with step (IV), in particular a bellows (rubber bellows) is used internally for inflation. In other respects in terms of molding technology reference is made to the introduction to the description relating to the prior art for molded hoses.

If at least one other layer in the form of an intermediate layer made of a polymeric material is present, extrusion is likewise used.

In particular a textile material is used as reinforcement layer, and here again reference is made to the abovementioned section concerning the textile materials, and also to the preferred mesh parameters.

In the case of a three-layer molded item or three-layer molded hose, the reinforcement layer has direct contact with the internal layer. In the case of a four-layer molded item or four-layer molded hose, where there is an intermediate layer superposed on the internal layer, the reinforcement layer has direct contact with the intermediate layer. Step II here is therefore to be interpreted as encompassing firstly the direct application of the reinforcement layer to the internal layer, and also secondly the application of the reinforcement layer to an entire composite made of internal layer and intermediate layer. The same applies to the application of the external layer to the reinforcement layer in accordance with step III, in the event that an intermediate layer should be present between the reinforcement layer and the external layer; however, this is mostly not the case.

### BRIEF DESCRIPTION OF THE DRAWINGS

The invention will now be described with reference to the drawings wherein:

FIG. 1 is a longitudinal-section depiction of a three-layer molded hose; and,

FIG. 2 is a longitudinal-section depiction of a four-layer molded hose.

### DESCRIPTION OF THE PREFERRED EMBODIMENTS OF THE INVENTION

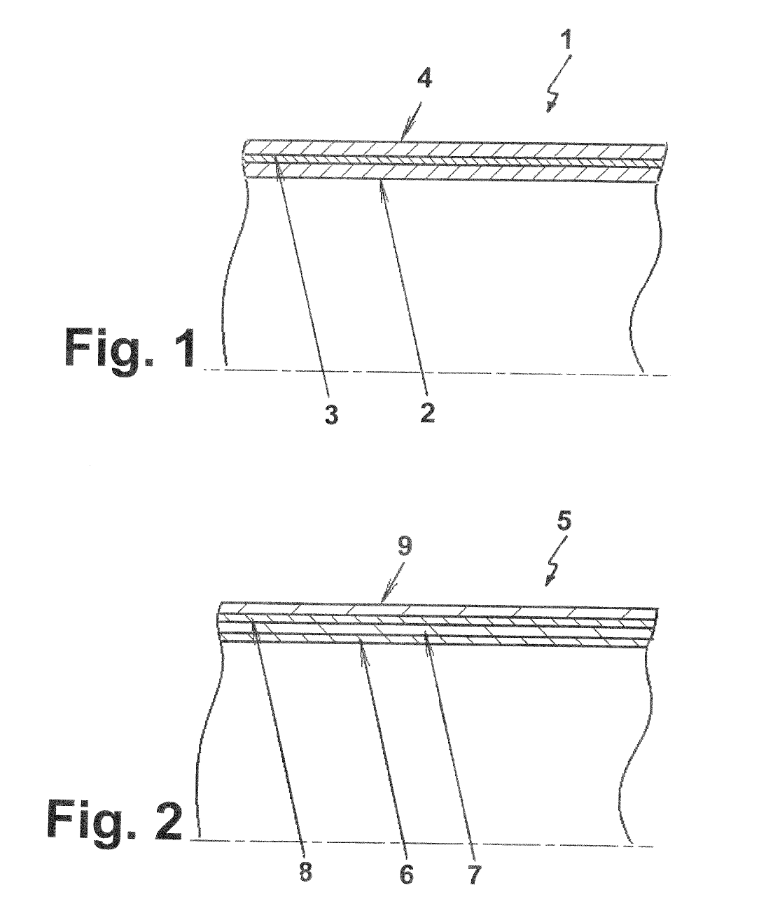

FIG. 1 shows a molded item 1 in the form of a three-layer molded hose. The molded hose here is composed exclusively of three layers, namely of an internal layer 2 in contact with the fluid (liquid, gas, et cetera) to be transported, of an embedded reinforcement layer 3, and of an external layer 4. The internal layer 2 and the external layer 4 are in each case composed of a crosslinked rubber mixture based on by way of example ACM and in each case have been extruded. The reinforcement layer 3 is composed of a fine knit made of by way of example an aramid. In the “plain stitch” type of knit, the fine knit has a high mesh count of in particular 36 mesh, the size of the knitting head being 3½″, and has a mesh height of in particular 2 mm.

FIG. 2 then shows a molded item in the form of four-layer molded hose as is presented in more detail by way of example in US 2012/0145275. The internal layer 6 is composed of a crosslinked rubber mixture based on by way of example ACM. The intermediate layer 7 and the external layer 9 are in each case likewise composed of a crosslinked rubber mixture, for example in each case based on EPDM. The internal layer 6, intermediate layer 7, and external layer 9 have in each case been extruded. The reinforcement layer 8 is likewise composed of a fine knit, for example again of an aramid. In respect of the preferred mesh parameters, reference is made to what has been said in the context of figure description 2.

It is understood that the foregoing description is that of the preferred embodiments of the invention and that various changes and modifications may be made thereto without departing from the spirit and scope of the invention as defined in the appended claims.

### KEY

(Part of the Description)
1 Molded item in the form of a three-layer molded hose
2 Internal layer
3 Reinforcement layer
4 External layer
5 Molded item in the form of a four-layer molded hose
6 Internal layer
7 Intermediate layer
8 Reinforcement layer
9 External layer

What is claimed is:

1. A molded item having a layer structure, the molded item comprising:
an internal layer made from a first polymeric material and having been extruded from a first rubber mixture;
an external layer made from a second polymeric material and having been extruded from a second rubber mixture; and,
a reinforcement layer embedded between the internal layer and the external layer;
wherein the reinforcement layer is a knit with a predetermined mesh count and a predetermined mesh height.

2. The molded item as claimed in claim 1 further comprising:
the first polymeric material being at least partially crosslinked;
the second polymeric material being at least partially crosslinked;
the first rubber mixture including at least one rubber component and being unblended or being a blend of two or more rubber components;
the second rubber mixture including at least one rubber component and being unblended or being a blend of two or more rubber components; and,
the first rubber mixture and the second rubber mixture each comprising further mixture ingredients.

3. The molded item as claimed in claim 2, wherein the at least one rubber component of the first rubber mixture is selected from the group consisting of acrylate rubber (ACM), ethylene-acrylate rubber (AEM), and fluororubber (FKM), or the at least one rubber component is a blend of ACM, AEM or FKM with at least one other rubber component.

4. The molded item as claimed in claim 2, wherein the rubber component of the rubber mixture for the external layer is selected from the group consisting of ACM, AEM, ethylene-propylene-rubber (EPM), ethylene-propylene-diene copolymer (EPDM), FKM, and vinyl methyl polysiloxanes (VMQ), or the rubber component of the rubber mixture for the external layer is a blend of ACM, AEM, EPM, EPDM, FKM or VMQ with at least one other rubber component.

5. The molded item as claimed in any of claim 1, wherein the reinforcement layer is a textile material.

6. The molded item as claimed in claim 5, wherein the textile material is selected from the group consisting of a polyamide (PA), a polyimide (PI), an aramid, a polyvinyl acetal (PVA), polyvinyl alcohol (PVAL), cotton (CO), modal (CMD), rayon (CV), a polyetheretherketone (PEEK), a polyester, a polysulfone (PSU), a polyaxadiazole (POD), polybenzoxazole (PBO), polyphenylene, and a polyphenylene derivative, or a mixture thereof.

7. The molded item as claimed in claim 6, wherein the aramid is para-aramid or meta-aramid.

8. The molded item as claimed in claim 6, wherein the polyester is polyethylene therephthalate (PET) or polyethylene 2,6-naphthalate (PEN).

9. The molded item as claimed in claim 6, wherein the polyphenylene derivative is polyphenylene sulfide (PPS).

10. The molded item as claimed in claim 1, wherein the predetermined mesh count is of from 30 to 40 mesh; and,
wherein a size of a knitting head for knitting the reinforcement layer is of from 2.5″ to 4″.

11. The molded item as claimed in claim 1, wherein the predetermined mesh height is of from 1.5 mm to 2.5 mm.

12. The molded item as claimed in claim 1, further comprising an intermediate layer between the inner layer and the reinforcement layer.

13. A process for the production of a molded item having a layer structure comprising:
extruding a first polymeric material from a first rubber mixture to form an internal layer;
optionally, providing an intermediate layer on the internal layer;
knitting a reinforcement layer having a predetermined mesh count and a predetermined mesh height;
applying the reinforcement layer to the internal layer or to the intermediate layer;
extruding a second polymeric material from a second rubber mixture to form an external layer and applying the external layer to the reinforcement layer to form a preform; and,
subjecting the preform to at least one final operation in a mold.

14. The process as claimed in claim 13, wherein the first rubber mixture and the second rubber mixture are each at least partially crosslinkable rubber mixtures, the process further comprising:
vulcanizing the preform in the mold; and,
at least partially crosslinking the first rubber mixture and the second rubber mixture.

15. The process as claimed in claim 13, wherein a textile material is used as the reinforcement layer.

16. The process as claimed in claim 13, wherein the predetermined mesh count is of from 30 to 40 mesh; and,
wherein a knitting head with a size of from 2.5″ to 4″ is used to knit the reinforcement layer.

17. The process as claimed in claim 13, wherein the predetermined mesh height is of from 1.5 mm to 2.5 mm.

18. The process as claimed in claim 13, wherein the production of the molded item is carried out continuously.

19. The process as claimed in claim 13, wherein the at least one final operation includes internally inflating the preform in the mold with a bellows.
